(19) United States
(12) Patent Application Publication
(10) Pub. No.: US 2026/0064429 A1
(43) Pub. Date: Mar. 5, 2026

(54) PERFORMANCE OPTIMIZER FOR UNDERSIZED POWER ADAPTERS

(71) Applicant: DELL PRODUCTS L.P., Round Rock, TX (US)

(72) Inventors: I-Huei Huang, Banqiao District (TW); Ming-Feng Wu, Beitou District (TW); Fan Hsiao, New Taipei City (TW); Hsu-Jui Chuang, New Taipei City (TW)

(21) Appl. No.: 18/824,040

(22) Filed: Sep. 4, 2024

(51) Int. Cl. G06F 9/4401

(52) U.S. Cl. CPC G06F 9/4401

(57) ABSTRACT

An information handling system, comprising an embedded controller configured to remove a first power setting of the information handling system in response to a determination that a power adapter plugged in the information handling system is undersized. The embedded controller is further configured to determine a second power setting based on a power rating of the power adapter and transmit an advanced configuration and power interface (ACPI) command to a basic input/output system (BIOS) to set the information handling system to the second power setting. The BIOS is configured to determine an offset value for a total graphics power based on the power rating of the power adapter subsequent to receipt of the ACPI command and notify a graphics processing unit of the offset value.

### FIELD OF THE DISCLOSURE

The present disclosure generally relates to information handling systems, and more particularly relates to performance optimizer for undersized power adapters.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system, comprising an embedded controller configured to remove a first power setting of the information handling system in response to a determination that a power adapter plugged in the information handling system is undersized. The embedded controller is further configured to determine a second power setting based on a power rating of the power adapter and transmit an advanced configuration and power interface (ACPI) command to a basic input/output system (BIOS) to set the information handling system to the second power setting. The BIOS is configured to determine an offset value for a total graphics power based on the power rating of the power adapter subsequent to receipt of the ACPI command and notify a graphics processing unit of the offset value.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system to optimize the performance of an undersized power adapter, according to an embodiment of the present disclosure;

FIG. 2 is a flowchart of a method to optimize the performance of an undersized power adapter, according to an embodiment of the present disclosure;

FIG. 3 is a table to lookup a total graphics power (TGP) offset value and/or TGP power setting for an undersized power adapter, according to an embodiment of the present disclosure; and

FIG. 4 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

External power adapters are commonly employed to convert alternating current (AC) wall current to direct current (DC) for powering portable information handling systems, such as laptop computers. A portable information handling system designed for maximum power, such as a gaming laptop, typically uses a barrel-type power adapter designed to support its maximum system power rating. For example, a default power adaptor that came with the purchase of the portable information handling system may be rated 240 watts. In certain situations, a user of the portable information handling system may not be able to use the default power adapter. For example, the user may have to use an undersized power adapter, such as a Universal Serial Bus (USB) Type-C power adapter that is rated less than 240 watts. Because the power adapter is undersized, the power provided to the portable information handling system via the power adapter may be limited. As such, the system performance of the laptop may be less than its rated maximum system performance. For example, this scenario can result in a drop in an application's frames-per-second (FPS).

However, the user may not have realized that he is using an undersized power adapter because the barrel-type power adapters with a power rating of 240 watts look similar to undersized power adapters with power ratings of 180 watts or less. As such, the user may be dissatisfied with the performance of his laptop without realizing the actual reason. Accordingly, there is a need to provide a system and method to optimize power provided by an undersized power adapter.

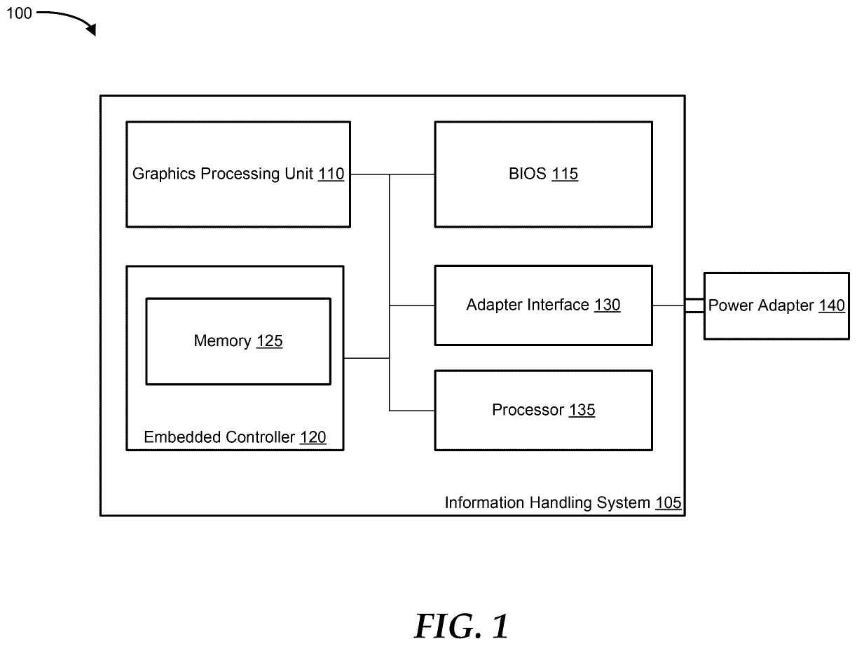

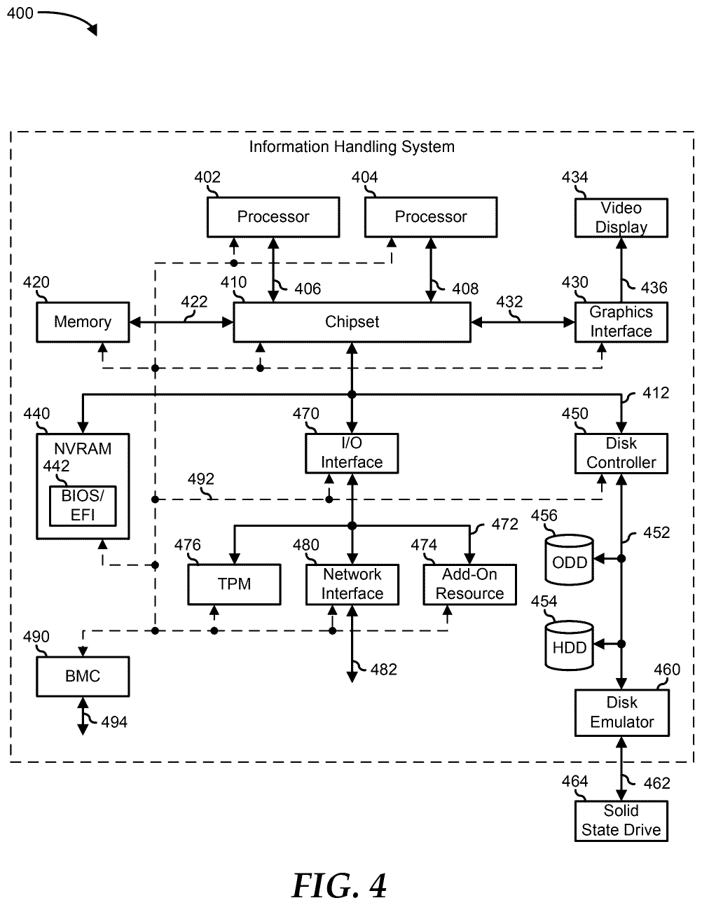

FIG. 1 illustrates a portion of a system 100 for optimizing performance of an undersized power adapter, according to an embodiment of the present disclosure. System 100 includes an information handling system 105 and a power adapter 140. Information handling system 105, which is similar to information handling system 400 of FIG. 4, includes a graphics processing unit (GPU) 110, a basic input/output system (BIOS) 115, an embedded controller 120, an adapter interface 130, and a processor 135. Embedded controller 120, which is similar to BMC 490 of FIG. 5, includes a memory 125. In one embodiment, adapter interface 130 may be connected to power adapter 140 when power adapter 140 is plugged into information handling system 105. GPU 110 may be connected to BIOS 115, embedded controller 120, adapter interface 130, and processor 135. However, any variety of connections between GPU 110, BIOS 115, embedded controller 120, adapter interface 130, and processor 135 are envisioned as falling within the scope of the present disclosure. In addition, connections between components may be omitted for descriptive clarity. The operations described herein as being performed by software and/or firmware may be performed or executed by processor 135, which is similar to processors 402 and 404 of FIG. 4. Other operations described herein may be performed by BIOS 115, embedded controller 120, and/or GPU 110.

Information handling system 105 may be a portable information handling system that includes laptops, notebooks, tablets, mobile phones, personal data assistants, or similar. Portable information handling systems are typically powered by an external AC power source via a power adapter, such as power adapter 140. In some cases, the portable information handling systems may also receive power supplied via a wired bus through a docking station, such as a USB Type-C wired bus. In other cases, the power may also be supplied wirelessly via an inductive charging pad.

Power adapter 140 may be configured to receive power from an AC power source, such as a wall outlet. Power adapter 140 may convert the AC power to DC power and provide the DC power to information handling system 105 via adapter interface 130, which may be a USB Type-C power adapter or similar. In addition, power adapter 140 may be configured to provide power state information to information handling system 105, such as via USB messages that include vendor-defined messages through adapter interface 130. For example, power adapter 140 may be configured to provide power source identification (PSID) information and one or more power data objects (PDOs). The power state information may include its power rating and other capabilities.

GPU 110 may be any suitable system, apparatus, or device operable to support dedicated graphics for information handling system 105. Specifically, GPU 110 may generate a feed of output images to be displayed to a user of information handling system 105. In one embodiment, GPU 110 may include a random-access memory (RAM), and power regulator specifically designed for processing video images to offload processing demands on a central processing unit (CPU) of information handling system 105, such as processor 135, and system RAM. The power consumption of GPU 110 during an operation may include a total graphics power (TGP) value. In one embodiment, a power setting associated with GPU 110 may be or include a TGP value representing an amount of power consumed by GPU 110 during an operation.

The TGP may be associated with different power settings, also referred to as power levels. Each TGP power setting may be associated with a degree of power consumption associated with the TGP. A TGP power setting may describe the power state of GPU 110 independently of other devices in information handling system 105 or the system power state of information handling system 105. The power settings may be characterized by several attributes associated with GPU 110, such as power consumption, operational context, power source, etc.

For illustration purposes, the TGP power settings may include D1, D2, D3, D4, and D5 power settings. In this example, the D1 power setting may be associated with maximum performance, wherein power adapter 140 is plugged into an AC power outlet, and information handling system 105 draws power from the AC power outlet. The D2 power setting may be associated with normal performance, wherein information handling system 105 draws power from a battery. The power consumption of GPU 110 when in the D2 power setting may be less than its power consumption when GPU 110 is in the D1 power setting. In addition, the D2 power setting may be associated with information handling system 105 under thermal protection. The D3, D4, and D5 power settings may be associated with other conditions associated with information handling system 105 and/or GPU 110, such as by its manufacturer. Each of the TGP power settings may have a power consumption that is a portion of the TGP of GPU 110, wherein the D5 power setting may have the least power consumption in comparison to the other TGP power settings as illustrated herein.

Power adapter 140 may include a connector, such as a single wire barrel connector, a USB Type-C connector, etc. Power adapter 140 operates to receive power from an AC power source and convert the supplied power to DC power for information handling system 105. In addition, power adapter 140 may be configured to provide information, such as power supply wattage to one or more components of information handling system 105. For example, power adapter 140 may be configured to provide the information to embedded controller 120 and/or BIOS 115 via adapter interface 130. In one example, adapter interface 130 may be a USB Type-C interface.

Embedded controller 120, which is similar to BMC 490 of FIG. 4, may be configured to receive and/or collect the information from power adapter 140. The information may be used to determine whether power adapter 140 is an undersized power adapter or not. Embedded controller 120 may receive and/or collect the information via adapter interface 130. Generally, power adapters come in all sizes and ratings, such as travel adapters, dock adapters, conference room adapters, etc. As used herein, the term “undersized” power adapter or power source may refer to a power adapter or power source that is less than the rated power wattage of an information handling system and/or GPU. As such the undersized power adapter may not be sufficient to support maximum, peak, and/or sustained power consumption of the information handling system. In various embodiments, an undersized adapter may also refer to an adapter or power source that is not sufficient to support the maximum or peak performance. In one example, if information handling system 105 is rated at 240 watts, then power adapter 140 is an undersized power adapter if its power rating is less than 240 watts. The undersized power adapter may be of various types, such as barrel, USB Type-C, USB Type-C docking, among others.

Embedded controller 120 may be configured to access a memory, such as memory 125 to identify a TGP power setting or TGP power profile associated with GPU 110 and/or information handling system 105. Memory 125 may be configured to store a plurality of power settings or power profiles associated with the TGP of the GPU. These power settings or power profiles may also be referred to as TGP power settings or TGP power profiles. Each of the TGP power settings is associated with a modified also referred to as an updated TGP value, wherein the updated TGP value includes a TGP offset value added to a base TGP value. As such, the base TGP value is less than the updated TGP value. The TGP offset value may be associated with a power adapter type and/or power rating. In addition, the TGP offset value may be determined based on laboratory analysis and measurements of GPU performance. Although memory 125 is shown included in embedded controller 120, memory 125 may be distinct from embedded controller 120.

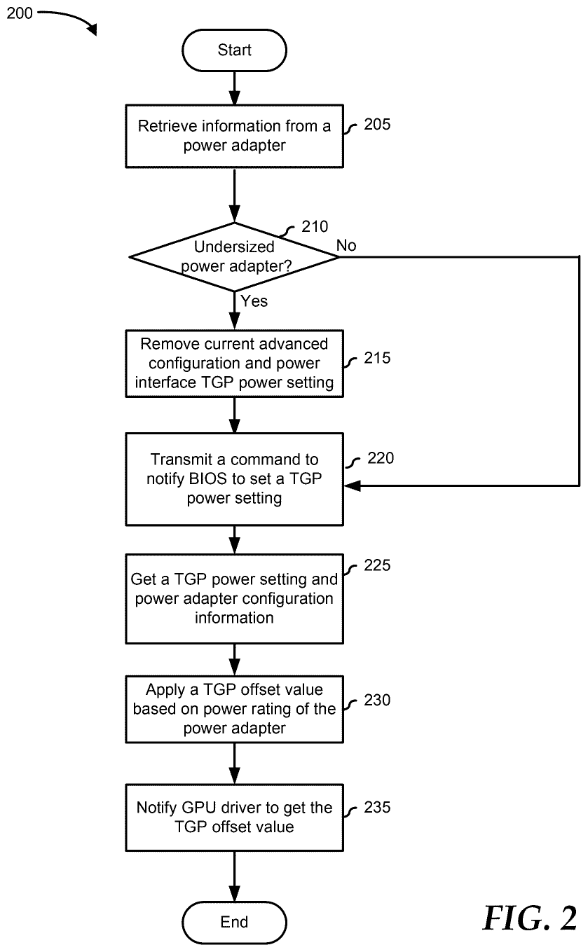

BIOS 115, which is similar to BIOS/EFI 142 of FIG. 2, may be configured to communicate with embedded controller 120 and/or GPU 110. In particular, BIOS 115 may be configured to receive and/or transmit commands from embedded controller 120 and GPU 110. For example, BIOS 115 may receive a command from embedded controller 120 to update a TGP power setting to a particular setting. BIOS 115 may also transmit a command to adjust a TGP value.

Those of ordinary skill in the art will appreciate that the configuration, hardware, and/or software components of system 100 depicted in FIG. 1 may vary. For example, the illustrative components within system 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description. In addition, the functions, and features of various components of system 100 and power adapter 140 in particular are in the context of USB specification for power delivery. However, undersized power adapters other than USB Type-C power adapters are expected to benefit from the teachings of the present disclosure, such as a power source or an undersized charging pad.

FIG. 2 illustrates a flowchart of a method 200 for optimizing the performance of an undersized power adapter, according to an embodiment of the present disclosure. Method 200 may be performed by any suitable component of system 100 including, but not limited to, embedded controller 120 and BIOS 115 of FIG. 1. While embodiments of the present disclosure are described in terms of the components of system 100 of FIG. 1, it should be recognized that other components may be utilized to perform the described method. One of skill in the art will appreciate that this flowchart explains a typical example, which can be extended to other methods in practice.

Method 200 typically starts at block 205 where an embedded controller may retrieve information from a power adapter that is plugged into a portable information handling system. For example, the embedded controller may retrieve PSID information and/or PDOs from the power adapter. The information may include data associated with the capabilities of the power adapter.

The method proceeds to decision block 210 where the embedded controller may determine whether the plugged-in power adapter is an undersized adapter based on the information retrieved in block 205. For example, the embedded controller may compare the power rating of the power adapter with the power rating of the information handling system and/or the GPU. The power adapter may be deemed undersized if its power rating is less than the power rating of the information handling system and/or the GPU. If the power adapter is undersized, then the “YES” branch is taken, and the method proceeds to block 215. If the power adapter is not undersized, then the “NO” branch is taken, and the method proceeds to block 220.

At block 215, the embedded controller may remove a current Advanced Configuration and Power Interface (ACPI) TGP power setting. The current TGP power setting may initially be set to the D2/D3 power setting based on a recommendation of an original equipment manufacturer of the power adapter. Further, the current TGP power setting may be associated with a higher power setting associated with the GPU and/or information handling system. However, the current TGP power setting may provide a power limitation condition resulting in lower performance of the GPU and/or information handling system with use of the undersized power adapter. By removing the current TGP power setting, such as via a D-notify command to the BIOS, the power limitation condition may also be removed. D-notify command may be used to change a GPU power limit through an ACPI call, also referred to as an ACPI command.

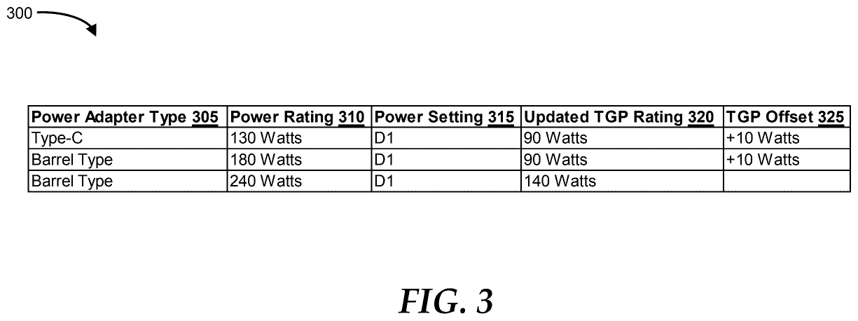

The method may proceed to block 220 where the embedded controller may determine a new TGP power setting for the information handling system or the GPU. In one embodiment, the embedded controller may use a lookup table, similar to a table 300 of FIG. 3 to determine the new TGP power setting. The new TGP power setting may be based on the type and power rating of the power adapter. The embedded controller may notify the BIOS via a D-notify command or an ACPI call to set the TGP power setting to the new TGP power setting. In one example, the new TGP power setting may be associated with a default power adapter. The default power adapter may have a power rating that is equal to or greater than the power rating of the information handling system or the GPU. In particular, the embedded controller may transmit a command, such as a D-notify command or an ACPI call to the BIOS to set the TGP power setting to the D1 power setting. As such, power consumption of removed TGP power setting is less than power consumption of new TGP power setting.

The method may proceed to block 225, where the BIOS may receive the command or ACPI call transmitted by the embedded controller at block 220. Accordingly, the BIOS may set the TGP power setting based on the received command. The command transmitted may also include configuration information associated with the power adapter, such as the power adapter size and/or power rating. In another embodiment, the BIOS may retrieve the information from the power adapter via an adapter interface. The method may proceed to block 230, where the BIOS may determine and set a TGP offset value based on the size or power rating of the power adapter. The TGP offset may be based on the new TGP power setting. In one example, the BIOS may use a lookup table similar to table 300 of FIG. 3 to determine the TGP offset value.

The method may proceed to block 235 where the BIOS may notify a driver of the GPU to get the new TGP offset value and apply the TGP offset value to a base TGP. The TGP offset may increase the value of the base TGP resulting in an updated TGP value. This updated TGP value may increase or optimize the performance of the GPU and/or information handling system similar to the performance associated with the default power adapter. This allows the method to maximize the TGP power setting for the undersized power adapter. For example, typically the TGP associated with the undersized power adapter prior to the present disclosure may be limited to 55 watts. With the TGP offset, the updated TGP value associated with the undersized power adapter may be increased to 90 watts, improving the performance of the GPU and/or information handling system and better frames per second. Accordingly, the TGP power setting may also be based on the updated TGP value. For example, instead of the TGP power setting set to the D2 power setting with limited performance capability, the TGP power setting may be set to the D1 power setting, which is associated with the default power adapter and/or maximum performance. Accordingly, in one scenario, a user can choose a smaller or lighter power adapter when traveling without an obvious performance drop. Afterwards, the method ends.

In an example, method 200 may be performed by any suitable component including, but not limited to, processor 135, embedded controller 120, and/or BIOS 115 of FIG. 1. It will be readily appreciated that not every method step set forth in this flow diagram is always necessary and that certain steps of the methods may be combined, performed simultaneously, in a different order, or perhaps omitted, without varying from the scope of the disclosure.

FIG. 3 illustrates a portion of a table 300 to look up a TGP offset value and/or TGP power setting for an undersized power adapter, according to an embodiment of the present disclosure. Table 300 includes several columns that include a power adapter type 305, a power rating 310, a power setting 315, an updated TGP rating 320, and a TGP offset 325. Power adapter type 305 includes different power adapter type values, such as USB Type-C and barrel plug types. Power rating 310 includes different TGP power ratings associated with each power adapter type. In this example, a USB Type-C power adapter has a power rating of 130 watts while barrel type power adapter has a power rating of 180 watts or 240 watts. Power setting 315 includes the TGP power setting associated with each power adapter type and/or power rating.

Updated TGP rating 320 includes power ratings associated with each power adapter type and/or power rating after a TGP offset value is applied to a base TGP rating. A base TGP rating may refer to a TGP associated with the undersized power adapter prior to the present disclosure. For example, the base TGP may be associated with the D2 power setting in block 215. TGP offset 325 includes various TGP offset values based on power adapter type and power rating. The TGP offset values may be identified in a laboratory setting to determine the maximum performance for an undersized power adapter. Accordingly, to look up the TGP offset value, the BIOS may first determine the type and power rating of a power adapter. For example, if the power adapter is a USB Type-C power adapter with a power rating of 130 watts, then the TGP offset value may be equal to 10 watts, while the TGP power setting may be set to the D1 power setting with an updated TGP rating of 90 watts.

FIG. 4 illustrates an embodiment of an information handling system 400 including processors 402 and 404, a chipset 410, a memory 420, a graphics adapter 430 connected to a video display 434, a non-volatile RAM (NVRAM) 440 that includes a BIOS/extensible firmware interface (BIOS/EFI) module 442, a disk controller 450, a hard disk drive (HDD) 454, an optical disk drive 456, a disk emulator 460 connected to a solid-state drive (SSD) 464, an input/output (I/O) interface 470 connected to an add-on resource 474 and a trusted platform module (TPM) 476, a network interface 480, and a baseboard management controller (BMC) 490. Processor 402 is connected to chipset 410 via processor interface 406, and processor 404 is connected to the chipset via processor interface 408. In a particular embodiment, processors 402 and 404 are connected together via a high-capacity coherent fabric, such as a HyperTransport link, a QuickPath Interconnect, or the like. Chipset 410 represents an integrated circuit or group of integrated circuits that manage the data flow between processors 402 and 404 and the other elements of information handling system 400. In a particular embodiment, chipset 410 represents a pair of integrated circuits, such as a northbridge component and a southbridge component. In another embodiment, some or all of the functions and features of chipset 410 are integrated with one or more of processors 402 and 404.

Memory 420 is connected to chipset 410 via a memory interface 422. An example of memory interface 422 includes a Double Data Rate (DDR) memory channel and memory 420 represents one or more DDR Dual In-Line Memory Modules (DIMMs). In a particular embodiment, memory interface 422 represents two or more DDR channels. In another embodiment, one or more of processors 402 and 404 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 420 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 430 is connected to chipset 410 via a graphics interface 432 and provides a video display output 436 to a video display 434. An example of a graphics interface 432 includes a Peripheral Component Interconnect-Express (PCIe) interface and graphics adapter 430 can include a four-lane (x4) PCIe adapter, an eight-lane (x8) PCIe adapter, a 16-lane (x16) PCIe adapter, or another configuration, as needed or desired. In a particular embodiment, graphics adapter 430 is provided down on a system printed circuit board (PCB). Video display output 436 can include a DVI, an HDMI, a DisplayPort interface, or the like, and video display 434 can include a monitor, a smart television, an embedded display such as a laptop computer display, or the like.

NVRAM 440, disk controller 450, and I/O interface 470 are connected to chipset 410 via an I/O channel 412. An example of I/O channel 412 includes one or more point-to-point PCIe links between chipset 410 and each of NVRAM 440, disk controller 450, and I/O interface 470. Chipset 410 can also include one or more other I/O interfaces, including a PCIe interface, an Industry Standard Architecture (ISA) interface, a Small Computer Serial Interface (SCSI) interface, an I²C interface, a System Packet Interface, a USB, another interface, or a combination thereof. NVRAM 440 includes BIOS/EFI module 442 that stores machine-executable code (BIOS/EFI code) that operates to detect the resources of information handling system 400, to provide drivers for the resources, to initialize the resources, and to provide common access mechanisms for the resources. The functions and features of BIOS/EFI module 442 will be further described below.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an institute of electrical and electronics engineers (IEEE) 1394 (Firewire) interface, a proprietary interface, or a combination thereof. Alternatively, SSD 464 can be disposed within information handling system 400.

I/O interface 470 includes a peripheral interface 472 that connects the I/O interface to an add-on resource 474, to TPM 476, and to network interface 480. Peripheral interface 472 can be the same type of interface as I/O channel 412 or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral interface 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on a separate circuit board, or add-in card disposed within information handling system 400, a device that is external to the information handling system, or a combination thereof.

Network interface 480 represents a network communication device disposed within information handling system 400, on a main circuit board of the information handling system, integrated onto another component such as chipset 410, in another suitable location, or a combination thereof. Network interface 480 includes a network channel 482 that provides an interface to devices that are external to information handling system 400. In a particular embodiment, network channel 482 is of a different type than peripheral interface 472 and network interface 480 translates information from a format suitable to the peripheral channel to a format suitable to external devices.

In a particular embodiment, network interface 480 includes a NIC or host bus adapter (HBA), and an example of network channel 482 includes an InfiniBand channel, a Fibre Channel, a Gigabit Ethernet channel, a proprietary channel architecture, or a combination thereof. In another embodiment, network interface 480 includes a wireless communication interface, and network channel 482 includes a Wi-Fi channel, a near-field communication (NFC) channel, a Bluetooth® or Bluetooth-Low-Energy (BLE) channel, a cellular-based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 482 can be connected to an external network resource (not illustrated). The network resource can include another information handling system, a data storage system, another network, a grid management system, another suitable resource, or a combination thereof.

BMC 490 is connected to multiple elements of information handling system 400 via one or more management interface 492 to provide out-of-band monitoring, maintenance, and control of the elements of the information handling system. As such, BMC 490 represents a processing device different from processor 402 and processor 404, which provides various management functions for information handling system 400. For example, BMC 490 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 490 can vary considerably based on the type of information handling system. BMC 490 can operate in accordance with an Intelligent Platform Management Interface (IPMI). Examples of BMC 490 include an Integrated Dell® Remote Access Controller (iDRAC).

Management interface 492 represents one or more out-of-band communication interfaces between BMC 490 and the elements of information handling system 400 and can include an Inter-Integrated Circuit (I2C) bus, a System Management Bus (SMBus), a Power Management Bus (PMBUS), a Low Pin Count (LPC) interface, a serial bus such as a USB or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 400, that is apart from the execution of code by processors 402 and 404 and procedures that are implemented on the information handling system in response to the executed code.

BMC 490 operates to monitor and maintain system firmware, such as code stored in BIOS/EFI module 442, option ROMs for graphics adapter 430, disk controller 450, add-on resource 474, network interface 480, or other elements of information handling system 400, as needed or desired. In particular, BMC 490 includes a network interface 494 that can be connected to a remote management system to receive firmware updates, as needed or desired. Here, BMC 490 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 490 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 490, an interface defined by the Distributed Management Taskforce (DMTF) (such as a Web Services Management (WSMan) interface, a Management Component Transport Protocol (MCTP) or, a Redfish® interface), various vendor-defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 490 is included on a main circuit board (such as a baseboard, a motherboard, or any combination thereof) of information handling system 400 or is integrated onto another element of the information handling system such as chipset 410, or another suitable element, as needed or desired. As such, BMC 490 can be part of an integrated circuit or a chipset within information handling system 400. An example of BMC 490 includes an iDRAC or the like. BMC 490 may operate on a separate power plane from other resources in information handling system 400. Thus BMC 490 can communicate with the management system via network interface 494 while the resources of information handling system 400 are powered off. Here, information can be sent from the management system to BMC 190 and the information can be stored in a RAM or NVRAM associated with the BMC. Information stored in the RAM may be lost after power-down of the power plane for BMC 490, while information stored in the NVRAM may be saved through a power-down/power-up cycle of the power plane for the BMC.

Information handling system 400 can include additional components and additional buses, not shown for clarity. For example, information handling system 105 can include multiple processor cores, audio devices, and the like. While a particular arrangement of bus technologies and interconnections is illustrated for the purpose of example, one of skill will appreciate that the techniques disclosed herein are applicable to other system architectures. Information handling system 400 can include multiple CPUs and redundant bus controllers. One or more components can be integrated together. Information handling system 400 can include additional buses and bus protocols, for example, I²C and the like. Additional components of information handling system 105 can include one or more storage devices that can store machine-executable code, one or more communications ports for communicating with external devices, and various input and output (I/O) devices, such as a keyboard, a mouse, and a video display.

For purposes of this disclosure information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 400 can include processing resources for executing machine-executable code, such as processor 402, a programmable logic array (PLA), an embedded device such as a System-on-a-Chip (SoC), or other control logic hardware. Information handling system 400 can also include one or more computer-readable media for storing machine-executable code, such as software or data.

Although FIG. 2 shows example blocks of method 200 in some implementations, method 200 may include additional blocks, fewer blocks, different blocks, or differently arranged blocks than those depicted in FIG. 2. Those skilled in the art will understand that the principles presented herein may be implemented in any suitably arranged processing system. Additionally, or alternatively, two or more of the blocks of method 200 may be performed in parallel. For example, blocks 230 and 235 of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
in response to determining, by a processor, that a power adapter plugged into an information handling system is undersized, removing a first power setting of the information handling system;
determining a second power setting based on a power rating of the power adapter;
transmitting an advanced configuration and power interface (ACPI) command to a basic input/output system (BIOS) to set the information handling system to the second power setting;
subsequent to receiving the ACPI command, determining, by the BIOS, an offset value to adjust a base total graphics power, wherein the offset value is based on the power rating of the power adapter; and
notifying a graphics processing unit of the offset value.

2. The method of claim 1, wherein the first power setting is associated with less power consumption than the second power setting.

3. The method of claim 1, wherein the offset value is used to adjust the base total graphics power of the graphics processing unit of the information handling system.

4. The method of claim 1, further comprising retrieving configuration information of the power adapter.

5. The method of claim 1, wherein the second power setting is associated with a default power adapter.

6. The method of claim 5, wherein the default power adapter is not undersized.

7. The method of claim 1, further comprising comparing the power rating of the power adapter with another power rating of the information handling system.

8. The method of claim 1, wherein the second power setting is based on an adjusted value of the base total graphics power of the graphics processing unit of the information handling system.

9. An information handling system, comprising:
an embedded controller configured to:
remove a first power setting of the information handling system in response to a determination that a power adapter plugged in the information handling system is undersized;
determine a second power setting based on a power rating of the power adapter; and
transmit an advanced configuration and power interface (ACPI) command to a basic input/output system (BIOS) to set the information handling system to the second power setting; and
the BIOS configured to:
determine an offset value for a total graphics power based on the power rating of the power adapter subsequent to receipt of the ACPI command; and
notify a graphics processing unit of the offset value.

10. The information handling system of claim 9, wherein the offset value is used to adjust a base total graphics power of the graphics processing unit of the information handling system.

11. The information handling system of claim 9, wherein the embedded controller is further configured to retrieve configuration information of the power adapter.

12. The information handling system of claim 9, wherein the second power setting is associated with a default power adapter.

13. The information handling system of claim 9, wherein the power adapter is a universal serial bus Type C power adapter.

14. The information handling system of claim 9, wherein the embedded controller is further configured to compare the power rating of the power adapter with another power rating of the information handling system.

15. A non-transitory computer-readable medium to store instructions that are executable to perform operations comprising:
in response to determining that a power adapter plugged into an information handling system is undersized, removing a first power setting of the information handling system;
determining a second power setting based on a power rating of the power adapter;
transmitting an advanced configuration and power interface (ACPI) command to a basic input/output system (BIOS) to set the information handling system to the second power setting;
subsequent to receiving the ACPI command, determining, by the BIOS, an offset value to adjust a base total graphics power, wherein the offset value is based on the power rating of the power adapter; and
notifying the graphics processing unit of the offset value.

16. The non-transitory computer-readable medium of claim 15, wherein the offset value is used to adjust the base total graphics power of the graphics processing unit of the information handling system.

17. The non-transitory computer-readable medium of claim 15, further comprising retrieving configuration information of the power adapter.

18. The non-transitory computer-readable medium of claim 15, wherein the power adapter is a barrel type power adapter.

19. The non-transitory computer-readable medium of claim 15, further comprising comparing another power rating of the information handling system with the power rating of the power adapter.

20. The non-transitory computer-readable medium of claim 15, wherein the second power setting is based on an adjusted value of the base total graphics power of the graphics processing unit of the information handling system.
